(19) United States
(12) Patent Application Publication
(10) Pub. No.: US 2015/0015395 A1
(43) Pub. Date: Jan. 15, 2015

(54) WIRELESS SECURITY SYSTEM

(71) Applicant: Synergy Information Systems Inc., Xinpu Township (TW)

(72) Inventors: Jia-Nian Liang, Xinpu Township (TW); Le-Shou Guo, Xinpu Township (TW); Lin Zhong, Xinpu Township (TW)

(73) Assignee: Synergy Information Systems Inc., Xinpu Township (TW)

(21) Appl. No.: 14/280,671

(22) Filed: May 19, 2014

(30) Foreign Application Priority Data
Jul. 12, 2013 (TW) 102213221

(51) Int. Cl. G08B 7/06; G08B 13/00

(52) U.S. Cl. CPC G08B 7/06; G08B 13/00
USPC 340/539.17

(57) ABSTRACT

The wireless security system contains a host machine, which in turn contains a processing unit. The processing unit contains an evaluation module which in turn contains a data storage module. The host machine further contains an input/output device, a mode switch module, a wireless transceiver module, a configuration module and an alert module. The wireless security system further contains at least a sensor which in turn contains a wireless transceiver module capable of communicating wirelessly with the wireless transceiver module of the host machine The wireless security system achieves both the functions of home security and home care by having the mode switch module and the evaluation module. A user can set up the time intervals when the evaluation should function. Then, through the mode switch module, a user can switch between different operating modes, thereby avoiding false alarms and achieving the reduction of energy consumption.

### BACKGROUND OF INVENTION

(a) Technical Field of the Invention

The present invention is generally related to security systems, and more particular to a wireless security system for both home care and home security with reduced energy consumption.

(b) Description of the Prior Art

A conventional security system, as illustrated in FIG. 1, contains a host machine 10 which can be a personal computer or a notebook computer. The host machine 10 contains an input device 12, a processing unit 11, and an output device 13. The input and output devices 12 and 13 are electrically connected to the processing unit 11. The input device 12 can be a keyboard, and the output device 13 can be a display. The security system further contains at least a sensor 14 electrically connected to the host machine 10. An operator can configure operating modes and other parameters into the sensor 14 through the input device 12. The sensory result by the sensor 14 is presented on the output device 13.

The configuration of the sensor 14 through the input device 12 is not a convenient and easy task. Especially when there are a large number of sensors 14, the sensor configuration can take quite some time and increase the workload of the operator. Additionally, the configuration and troubleshooting usually requires some professional expertise, an ordinary user most of time is not capable of this task. Furthermore, the operating modes of the security system sometimes should be configured dynamically in accordance with the dates and times. Without properly setting the operating mode of the security system, false alarms are common and need to be improved.

### SUMMARY OF THE INVENTION

Due to the conventional security system's incapability of switching operating modes, false alarms are common. An objective of the present invention is to provide a wireless security system having a mode switch module and an evaluation module. A user can set up the time intervals when the evaluation should function. Then, through the mode switch module, a user can switch between different operating modes, thereby avoiding false alarms and achieving the reduction of energy consumption.

To achieve the above objectives, the present invention provides a novel wireless security system for both home care and home security with reduced energy consumption.

The wireless security system contains a host machine, which in turn contains a processing unit. The processing unit contains an evaluation module which in turn contains a data storage module. The host machine further contains an input/output device, a mode switch module, a wireless transceiver module, a configuration module, all electrically connected with the processing unit, and an alert module electrically connected with the configuration module.

The wireless security system further contains at least a sensor which in turn contains a wireless transceiver module capable of communicating wirelessly with the wireless transceiver module of the host machine Each sensor further contains a processing unit, which in turn contains a data storage module electrically connected with the wireless transceiver module of the sensor.

The wireless security system achieves both the functions of home security and home care by having the mode switch module and the evaluation module.

A user can set up the time intervals when the evaluation should function. Then, through the mode switch module, a user can switch between different operating modes, thereby avoiding false alarms and achieving the reduction of energy consumption.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a conventional security system.

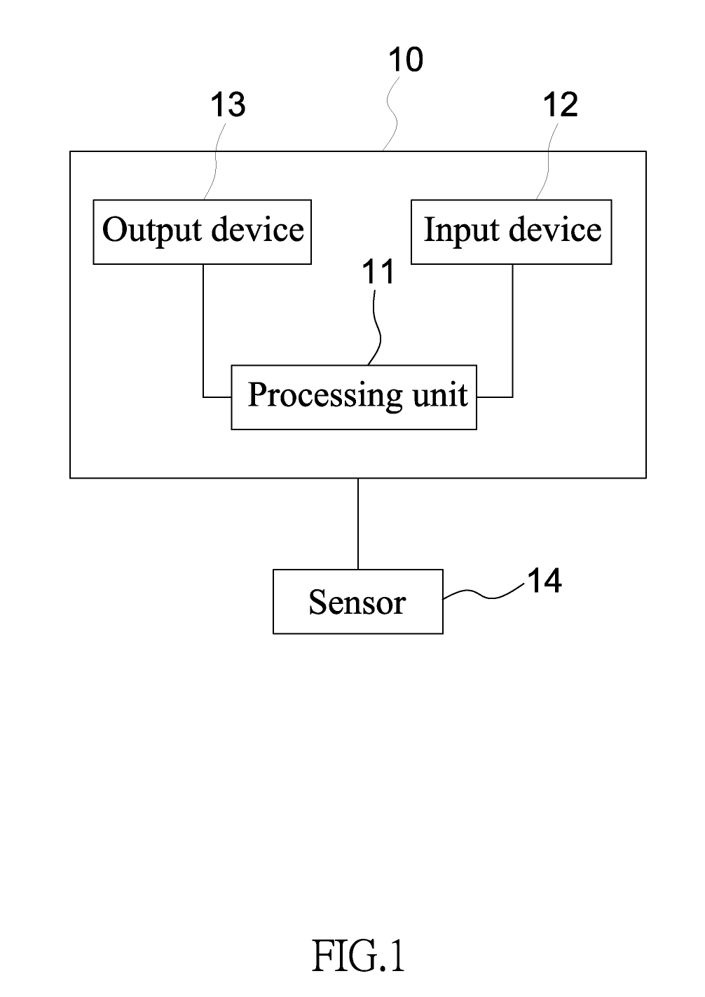

FIG. 2 is a functional block diagram showing a wireless security system according to the present invention.

FIG. 3 is a schematic diagram showing the overall operation of the wireless security system of FIG. 2.

FIG. 4 is a schematic diagram showing the operation of the wireless security system of FIG. 2 when it is under a security mode.

FIG. 5 is a schematic diagram showing the operation of the wireless security system of FIG. 2 when it is under a home-staying mode.

FIG. 6 is a functional block diagram showing additional components of a processing unit of the wireless security system of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

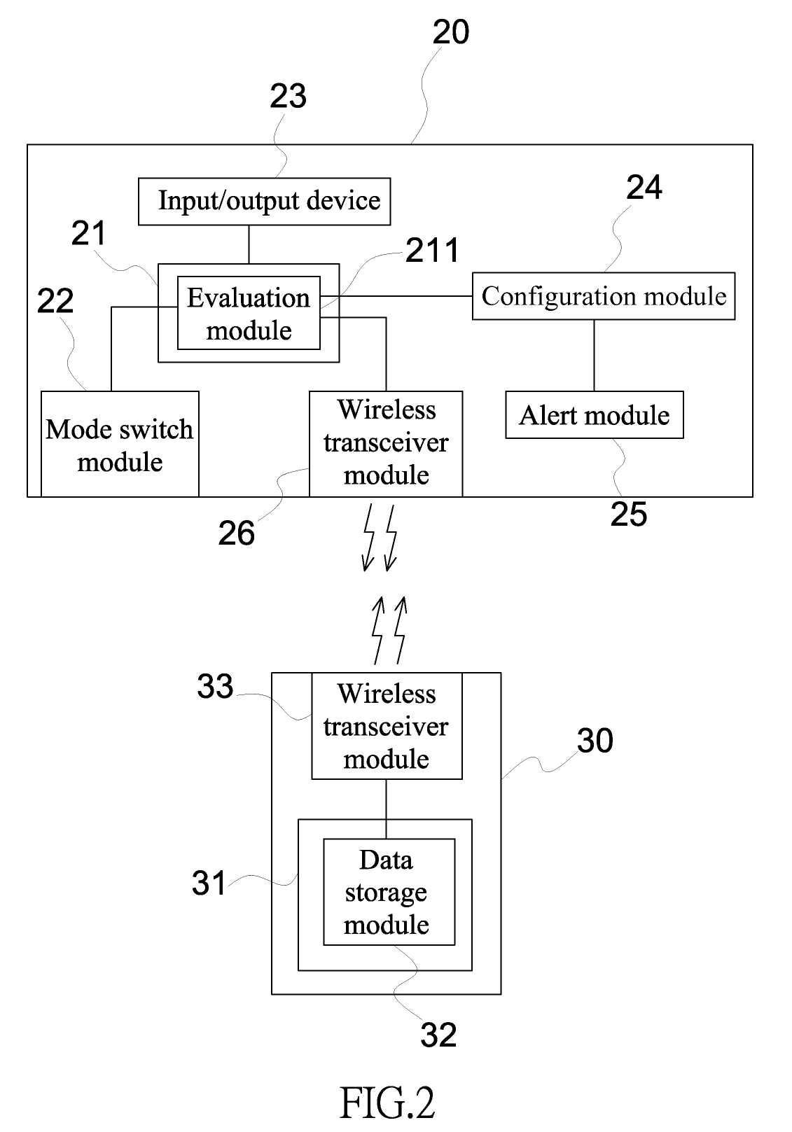

FIG. 2 is a functional block diagram showing a wireless security system according to the present invention.

As illustrated, the wireless security system contains a host machine 20, which in turn contains a processing unit 21. The processing unit 21 contains an evaluation module 211, which in turn contains a data storage module 212. The data storage module 212 can be a Random Access Memory (RAM), a Flash memory, or other non-volatile memory. The host machine 20 further contains an input/output device 23 which can be a touch-sensitive screen. The input/output device 23 is electrically connected with the processing unit 21. The host machine 20 also contains a mode switch module 22 electrically connected with the processing unit 21. The mode switch module 22 provides a security mode 221 and a home-staying mode 222. The host machine 20 additionally contains a wireless transceiver module 26 operating in accordance with Bluetooth, Zigbee, or other radio frequency (RF) protocol. The wireless transceiver module 26 is electrically connected to the processing unit 21. There is also a configuration module 24 electrically connected with the processing unit 21, which further contains a timer module 241 and a policy module 242, allowing a user to set up operation intervals and activation rules. Furthermore, there is an alert module 25 electrically connected with the evaluation module 24, for sending a notification via a wired network, a wireless network, a text message, a voice message, an e-mail, an alarm, or an on/off state of an electronic on/off device.

The wireless security system contains at least a sensor 30 which contains wireless transceiver module 33 capable of communicating wirelessly with the wireless transceiver module 26 of the host machine 20. Each sensor 30 contains a processing unit 31, which in turn contains a data storage module 32 electrically connected with the wireless transceiver module 33. The data storage module 32 can be a Random Access Memory (RAM), a Flash memory, or other non-volatile memory. Each sensor 30 is electrically connected with an external electronic device and is capable of detecting and controlling the external electronic device.

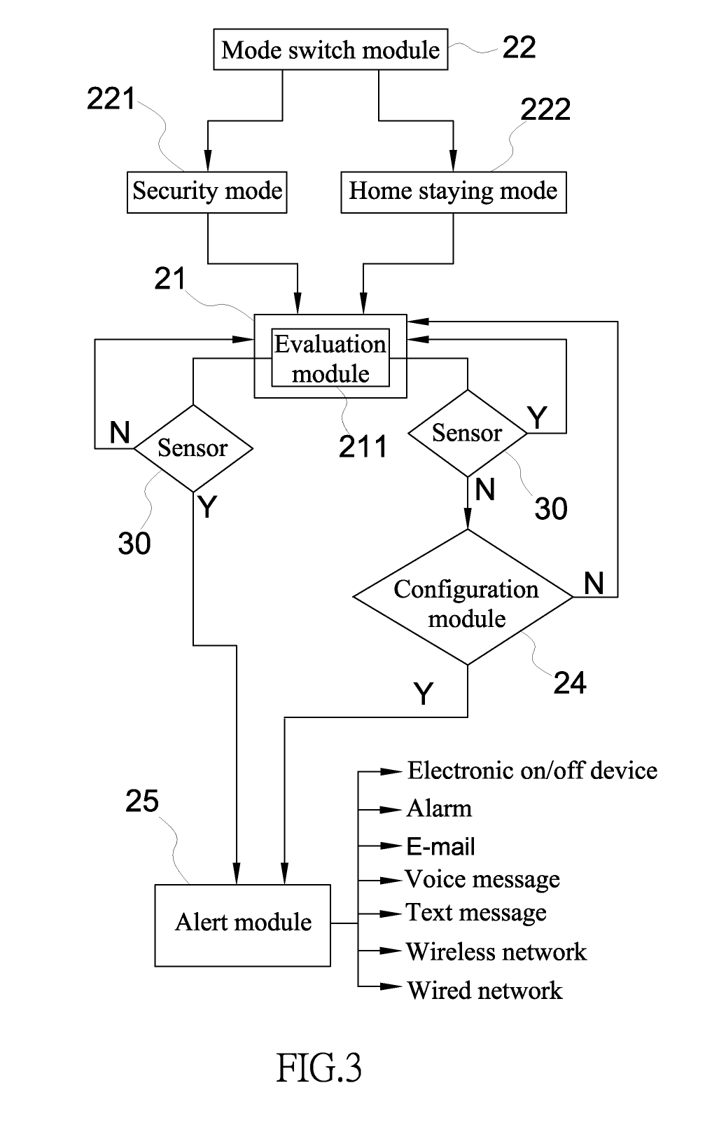

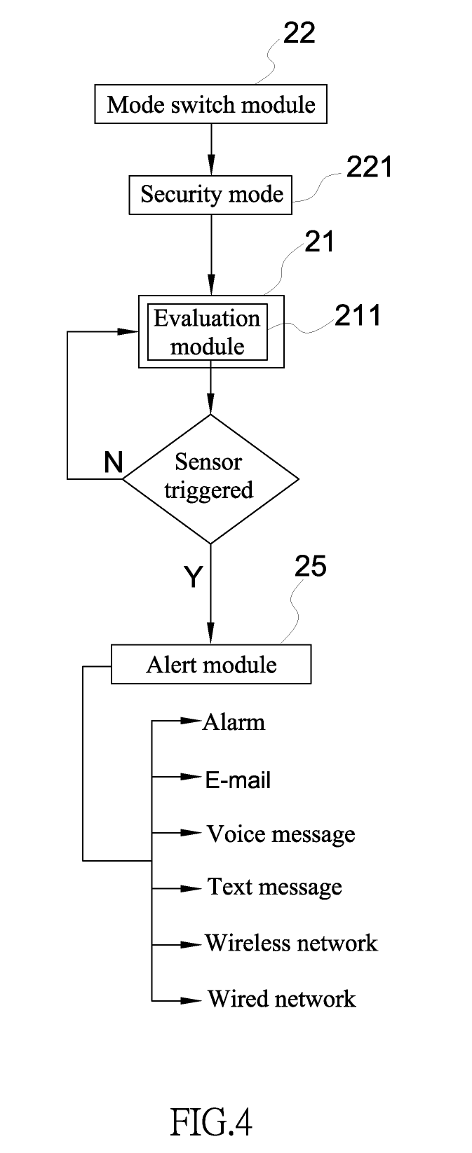

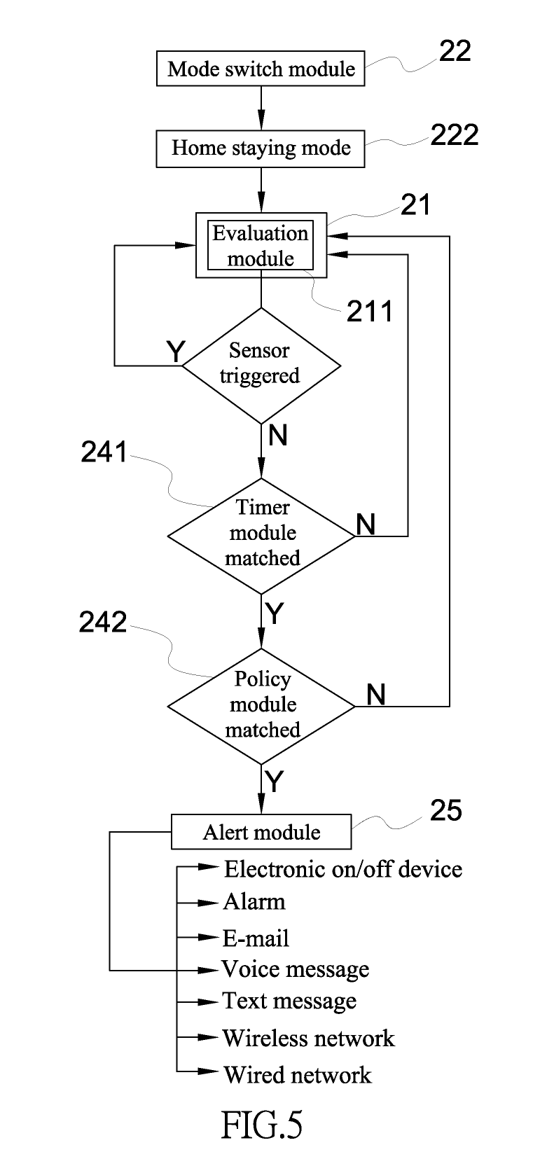

FIG. 3 is a schematic diagram showing an overall operation of the wireless security system of FIG. 2. As illustrated, the mode switch module 22 provides a security mode 221 and a home-staying mode 222, selectable by a user. When the wireless security system is installed in a house and when a user is to leave the house, the user can set the wireless security system to operate in the security mode 221 and the operation of wireless security system is shown in FIG. 4. As illustrated, when the mode switch module 22 is set to the security mode 221, the mode switch module 22 notifies the evaluation module 211 in the processing unit 21. The evaluation module 211 monitors whether a sensor 30 has sensed something and thereby has been triggered. If the sensor 30 is triggered (e.g., by sensing something is moving in the house), the evaluation module 211 activates the alert module 25, and the alert module 25, based on user configuration, will send out an a form of notification to the user via a wired network, a wireless network, a text message, a voice message, an email, or an alarm. On the other hand, if the sensor 30 is not triggered, the evaluation module 211 will continue to monitor whether a sensor 30 has been triggered or not. As such, the wireless security system achieves the function of home security. When the user (especially when the user is a senior citizen) stays in the house, the user can set the wireless security system to operate in the home-staying mode 222 via the mode switch module 22. As shown in FIG. 5, when the mode switch module 22 is set to the home-staying mode 222, the mode switch module 22 notifies the evaluation module 211 in the processing unit 21. The evaluation module 211 monitors whether a sensor 30 has sensed something and thereby has been triggered. If the sensor 30 is triggered (e.g., by sensing the user is moving in the house), the evaluation module 211 will continue to monitor whether a sensor 30 has been triggered or not. On the other hand, if the sensor 30 is not triggered, the evaluation module 211 signals the configuration module 24. Inside the configuration module 24, the timer module 241 provides user-configurable time intervals, and the policy module 242 provides user-configurable rules of activating alerts. As such, when the sensor 30 is not triggered, the time matches a time interval of the timer module 241, and the situation matches a rule of activating alerts, the configuration module 24 activates the alert module 25, and the alert module 25, based on user configuration, will send out an a form of notification to the user via a wired network, a wireless network, a text message, a voice message, an email, an alarm, or an on/off state of an electronic on/off device. On the other hand, if the sensor 30 is not triggered whereas the time does not match a time interval of the timer module 241 or the situation does not match a rule of activating alert, the configuration module 24 will notify the evaluation module 211 to continue monitoring whether a sensor 30 has been triggered or not. As described above, the wireless security system achieves the functions of home security and home care by the mode switch module 22. False alarms by the sensor 30 and energy consumption are reduced. Additionally, the alert module 25 is capable of controlling an on/off state of an electronic on/off device (e.g., configured in the alert module 25). Therefore, an external electronic device, when it is connected to the electronic on/off device, can be turned on or off in accordance with the timer intervals and activation rules set in the configuration module 24.

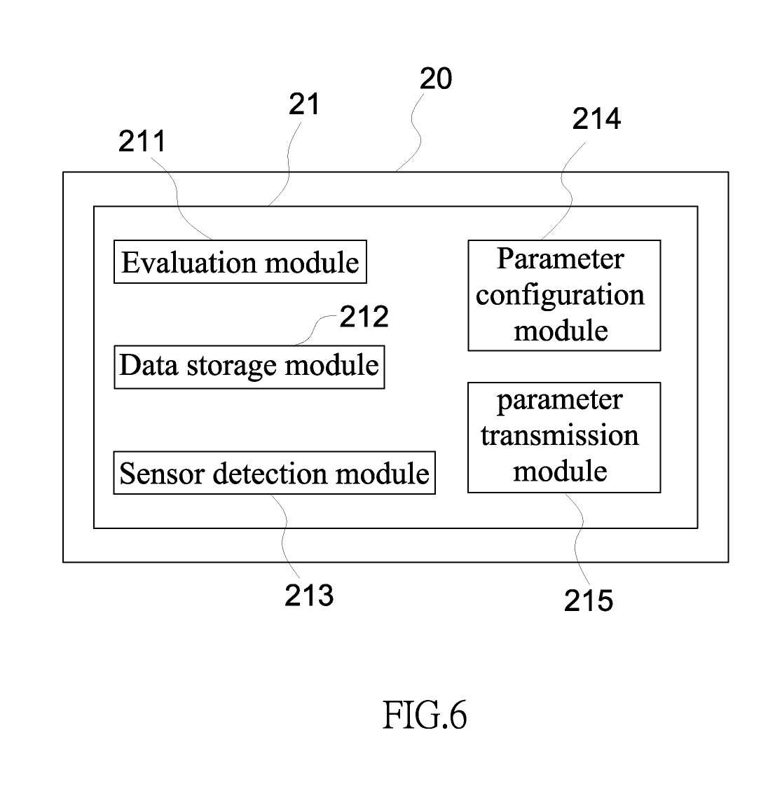

As illustrated in FIG. 6, the processing unit 21 can further contains a sensor detection module 213, a parameter configuration module 214, and a parameter transmission module 215. The sensor detection module 213 checks whether a sensor 30 is connected to the host machine 20. If the presence of the sensor 30 is detected, the parameter configuration module 214 accesses the data storage module 32 of the sensor 30 to see if the sensor 30 requires configuration of its parameters. This is a fully automatic process. Alternatively, the host machine 20 can first display a request message or turn on an indicator on the input/output device 23. A user then can enter a command to confirm that a sensor 30 requires configuration of parameters through the input/output device 23. This is a semi-automatic process. Under the fully automatic process or the semi-automatic process, if the parameter configuration module 214 determines that the sensor 30 requires configuration, the parameter transmission module 215 will deliver the parameter data stored in the data storage module 212 of the processing unit 21 to the sensor 30. Therefore, by storing the parameter data in the data storage module 212 in the host machine 20′s processing unit 21 and together with the sensor detection module 213, the parameter configuration module 214, and the parameter transmission module 215, the host machine 20 is capable of automatically or semi-automatically configuring the sensors 30, achieving enhanced operation speed, configuration time, and usage convenience.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wireless security system comprising a host machine and at least a sensor, where
the host machine comprises a processing unit;
the processing unit comprises an evaluation module;
the evaluation module comprise a data storage module;
the host machine further comprises an input/output device, a mode switch module, a wireless transceiver module, a configuration module, all electrically connected with the processing unit; and
the host machine further comprises an alert module electrically connected with the configuration module;
each sensor comprises a wireless transceiver module capable of communicating wirelessly with the wireless transceiver module of the host machine, and a processing unit; and
the processing unit of the sensor comprises a data storage module electrically connected with the wireless transceiver module of the sensor.

2. The wireless security system according to claim 1, wherein the data storage module of the host machine is one of a Random Access Memory (RAM), a Flash memory, and a non-volatile memory

3. The wireless security system according to claim 1, wherein the input/output device is a touch-sensitive screen.

4. The wireless security system according to claim 1, wherein the mode switch module provides a security mode and a home-staying mode.

5. The wireless security system according to claim 1, wherein the wireless transceiver module of the host machine operates in accordance with Bluetooth or Zigbee protocol.

6. The wireless security system according to claim 1, wherein the alert module is capable of sending a notification via one of a wired network, a wireless network, a text message, a voice message, an e-mail, and an alarm.

7. The wireless security system according to claim 1, wherein the data storage module of the sensor is one of a Random Access Memory (RAM), a Flash memory, and a non-volatile memory

8. The wireless security system according to claim 1, wherein the wireless transceiver module of the sensor operates in accordance with Bluetooth or Zigbee protocol.

9. The wireless security system according to claim 1, wherein the processing unit of each sensor further comprises a sensor detection module, a parameter configuration module, and a parameter transmission module.

10. The wireless security system according to claim 1, wherein the configuration module comprises a timer module and a policy module.
